(19) United States
(12) Patent Application Publication
(10) Pub. No.: US 2006/0076896 A1
(43) Pub. Date: Apr. 13, 2006

(54) SAFETY ALERT AND LIGHTING SYSTEM

(76) Inventors: RICHARD G. OSBORN, Strathmore (CA); MICHAEL J. ROBINSON, Calgary (CA)

Correspondence Address: BENNETT JONES;C/O MS ROSEANN CALDWELL, 4500 BANKERS HALL EAST, 855 - 2ND STREET, SW, CALGARY, AB, T2P 4K7, CA

(21) Appl. No.: 10/908,330

(22) Filed: May 6, 2005

(30) Foreign Application Priority Data
Oct. 8, 2004 (CA) 2,484,404

(51) Int. Cl. H05B 37/00

(52) U.S. Cl. 315/86; 315/129; 315/134

(57) ABSTRACT

The present invention relates to a safety alert and lighting system comprising a power source, an AC connection, a battery pack connected to the AC connection, a lighting system connected to the battery in the battery pack, one or more sensor devices and a relay. The relay will cause the lighting system to be activated and powered by the battery in certain selected situations. The lighting system is activated when power from the power source is interrupted or when a sensor device triggers the relay. The activated lighting system powered by the battery allows the inhabitants of a home to find candles or flashlights, in the circumstance of a power outage, or to exit the home safely if an unsafe environment, such as smoke, is detected by a sensor device.

### FIELD

The invention relates to a lighting system that may be activated by a safety alert device or a power outage.

### BACKGROUND

Safety alert systems for home use have existed for a number of years and are constantly adapting to new technology to become more and more effective. Smoke, carbon dioxide, gas and fire are some of the unsafe environments that can be detected by present day safety alert systems. Generally these safety alert systems include some form of alarm integrated into their configuration. When an unsafe environment is detected by the safety alert system then the alarm sounds to warn the inhabitants that they must vacate their home.

Many victims of accidents in the home die of inhalation of smoke and toxic gases. Most deaths and injuries occur due to crises that happen at night. An alarm from a safety alert detection system that sounds when the concentration of a hazardous substance pervades the home environment warns the inhabitants of the need to evacuate the premises. However, present day alert systems do not necessarily help the inhabitants to evacuate the premises safely after alerting them to an existing danger. Nor are the present day alert systems necessarily capable of deactivating other devices that if left in an active state may heighten the risk of injury or property damage.

### SUMMARY

The present invention relates to a safety alert and lighting system that is suitable for use in many different types of buildings, but is particularly suited for use in a home. In one embodiment, the invention comprises the following elements: a power source; an AC connection connected to the power source; a relay between the power source and the AC connection, the relay being connected to the power source and to the AC connection, and the relay comprising a switch which when deactivated will interrupt power flow to the AC connection; a battery connected to a charger, that is connected to the AC connection; a lighting system connected to the battery and powered by the battery when the switch is deactivated, and a sensor device connected the relay. The switch in the relay is deactivated when power flowing from the power source to the relay is interrupted, or when the sensor device is activated.

In another embodiment, the safety alert and lighting system comprises the following elements: a power source; an AC connection connected to the power source and to a charger, a battery connected to the charger; a lighting system capable of being powered by the battery, at least one sensor device and a relay connected to the power source, the sensor and the AC connection. The relay comprises at least one switch that is capable of interrupting the power flow to the AC connection when either the power flowing from the power source to the relay is interrupted or a sensor device is activated. When the relay interrupts the power flow to the AC connection, the lighting system is powered by the battery.

In yet another embodiment, the safety alert and lighting system has the following elements: a power source; a first relay between the power source and an AC connection, the relay being connected to the power source and to the AC connection, and the relay comprising a first switch which when deactivated will interrupt power flow to the AC connection; at least one second relay connected to the first relay, said second relay being connected to the power source and to at least one device and said second relay comprising a second switch which when deactivated will either interrupt the power flow, or cause power to flow, to the device; at least one sensor device connected to the first relay, a charger that is connected to the AC connection and a battery that is connected to the AC connection and to a lighting system that is powered by the battery when the power flow to the AC connection is interrupted. When power flowing from the power source to the first relay is interrupted, or when power flowing to the second relay is interrupted, or when the at least one sensor device is activated, the first switch is deactivated and the lighting system is powered by the battery, and the second switch is deactivated. In a preferred embodiment of this invention, the device connected to the second relay is a furnace, and when the second switch in the second relay is deactivated, the furnace turns off.

The invention is configured to perform two main functions. Firstly, when an interruption in the flow of power from the power source to the battery occurs the battery will supply power to the lighting system. In the absence of power flowing from the power source, power will be drawn from the battery. When power is drawn from the battery the lighting system will be activated.

A second function of the invention occurs when an alarm of a sensor device is triggered. Upon the alarm being sounded a normally closed contact within the relay, which is normally in a closed position, may be caused to move from a closed position to an open position. When the relay is in an open position a gap will exist in the flow of power from the power source and consequently power will be drawn from the battery. When power is drawn from the battery the lighting system will be activated.

Once the lighting system is activated the inhabitants of a home will be provided with light to help them to safely react to either the power shortage or the dangerous environment occurring within the house. Lights connected to the lighting system may be located within a variety of rooms and hallways throughout the house. Each light may be positioned so as to provide optimum lighting to aid a family to safely evacuate their home. Particular consideration may be given to providing optimum lighting in the situation that the home is filled with heavy smoke. To facilitate a safe exit through heavy smoke lights may be located closer to floor level to provide lighting if inhabitants have to crawl out of a smoke-filled home. Lights can be located and positioned in key areas within the home, such as near to the fuse box or at a staircase, to provide lighting that may aid the tenants in dealing with a crisis situation.

The safety alert system may reset itself automatically after it has been in use. As part of the reset process the battery may be recharged.

As is apparent, multiple sensor devices may be integrated into the present invention. For example, a smoke detector, a carbon dioxide monitor, a carbon monoxide monitor, a gas monitor or other sensor devices may all be simultaneously integrated into the present invention. Multiple sensor devices of a single type of device, such as multiple smoke detectors, may also be utilized. Upon the alarm of any one of a plurality of sensor devices sounding the alarms of all of the sensor devices may sound. An embodiment of the invention could also incorporate a single sensor device. When a single or multiple sensor device alarms sound the normally closed contact of the relay may be caused to move from a closed to an open position and the lighting system may consequently be turned on.

As is apparent, other functions could be integrated into the invention to occur upon the sounding of an alarm of a sensor device. For example, a furnace may be connected to the invention so that a second relay would trigger the furnace to be turned off at the same time as a first relay activated the lighting system. Both the lighting system and the furnace would react to the sounding of the alarm detected by individual relays attached to interconnected sensor devices. Turning off the furnace may avert injury to the inhabitants or property damage in the case of a dangerous environment within a home. Devices other than a furnace including water pipes, gas lines, gas fireplaces or a variety of other household devices may be integrated into the invention. Multiple devices may be integrated into the same embodiment of the invention each being connected to individual relays.

These and other features and advantages of the safety alert and lighting system according to the present invention will become more apparent with reference to the following detailed description and drawings.

### BRIEF DESCRIPTION OF THE DRAWINGS

FIG. 1 is a block diagram of an embodiment of the safety alert and lighting system with a lighting system attached.

FIG. 2 is a block diagram of an embodiment of the safety alert and lighting system with a lighting system attached and a relay integrated into the sensor device.

FIG. 3 is a block diagram of an embodiment of the safety alert and lighting system with a lighting system attached, demonstrating an alternate wiring arrangement.

FIG. 4 is a block diagram of an embodiment the safety alert and lighting system with multiple sensor devices and second relay attached to control a second function integrated therein.

### DETAILED DESCRIPTION OF PREFERRED EMBODIMENTS

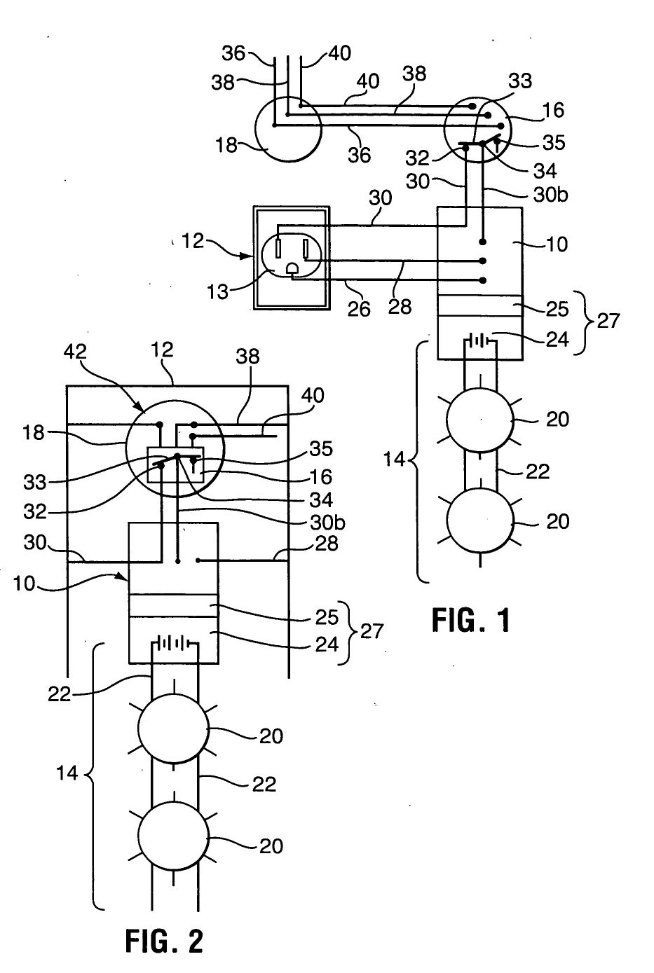

The safety alert and lighting system can be configured as generally shown in FIG. 1 to FIG. 4. Generally, an AC connection 10 connects, either directly or indirectly, a battery 24 to a power source 12. The AC connection 10 is simultaneously connected to a lighting system 14 and a relay 16. A sensor device 18 is wired into the relay.

The safety alert and lighting system can perform two functions. First, if power source 12 experiences an interruption in its power flow, lighting system 14 may be activated and powered by battery 24. Secondly, if sensor device 18 is triggered to sound its alarm due to an unsafe environment, relay 16 may cause the power to be interrupted between power source 12 and battery 24. When this occurs, lighting system 14 will be activated and powered by battery 24. Once the unsafe environment no longer exists, the invention will reset itself automatically.

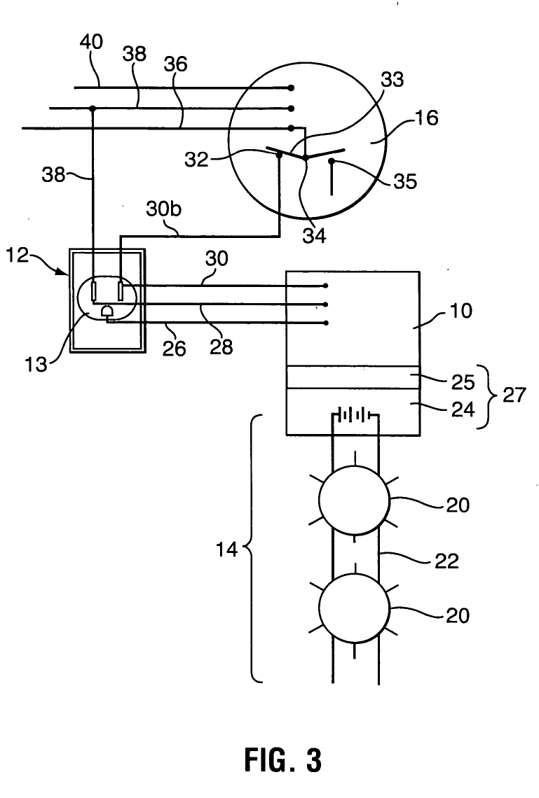

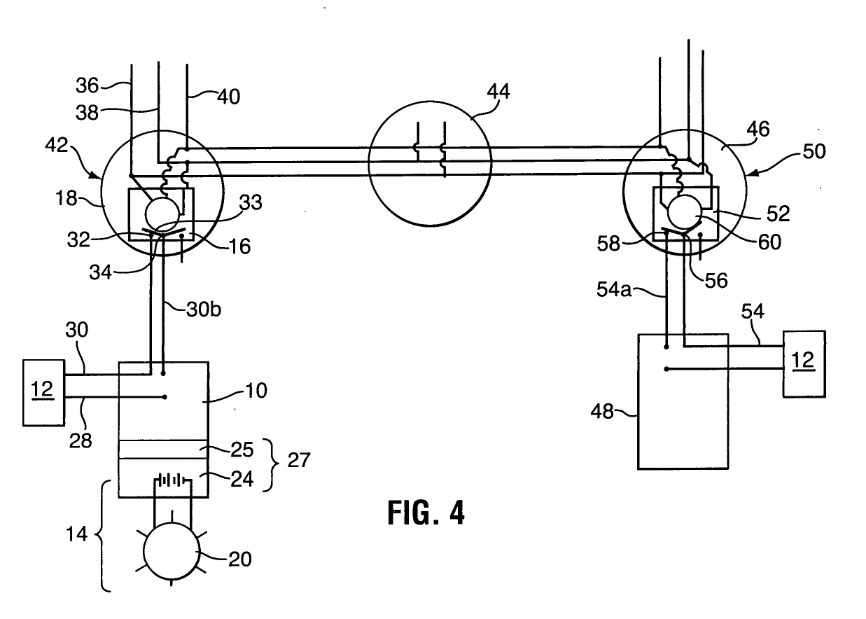

The embodiments shown in FIG. 1-4 demonstrate various means of assembling the components of the safety alert and lighting system disclosed herein. The embodiment shown in FIG. 1 incorporates a wall plug 13 connection of AC connection 10 to power source 12, which is connected to relay 16, the latter of which is connected to sensor device 18. The embodiment shown in FIG. 2 incorporates direct wiring to a power source 12 instead of a wall plug outlet connection and a sensor/relay device 42 that integrates sensor device 18 and relay 16 into a single device. The embodiment shown in FIG. 3 shows a wall plug 13 connection of AC connection 10 to power source 12, wherein relay 16 is connected between power source 12 and wall plug 13, to interrupt the flow of power from power source 12 to wall plug 13 when switch 33 is opened. FIG. 4 shows an embodiment incorporating multiple sensor devices 44 and 46 and a device 48 which may be activated or inactivated, all of which are connected to the sensor/relay device 42.

AC connection 10 functions to transmit power from power source 12 to a charger 25 and ultimately to battery 24, to keep battery 24 in a charged state. When the power supply to AC connection 10 is interrupted, as by an interruption in power to power supply 12 or to wall plug 13, or as by an interruption caused by relay 16, this interruption will cause lighting system 14 to be activated and powered by battery 24. AC connection 10 is an AC connection, which is known to those of skill in the art. Examples of suitable AC connections are 120 volt and 220 volt connections. In one embodiment, the AC connection is a 120 volt connection.

Battery pack 27 comprises a rechargeable battery 24 and a charger 25. Charger 25 connects to AC connection 10, recharges the battery 24, and comprises a switch, such as a relay, that activates battery 24 when charger 25 experiences an interruption in power caused by an interruption in power to AC connection 10. Battery packs useful in the present invention are known to those of skill in the art. One example of a battery pack useful in the present invention is a battery pack available from ReadyLite™, which battery pack comprises two 6 volt rechargeable batteries connected in sequence, and a charger.

Rechargeable battery 24 functions to provide power to lighting system 14 in the event that the power to AC connection 10 is interrupted, as described above. Rechargeable battery 24 supplies DC power to lighting system 14, at a number of different voltages, for example 6, 12 or 24 volts. Suitable rechargeable batteries for use herein are known to those of skill in the art. Rechargeable battery 24 can be one rechargeable battery or a series of rechargeable batteries, such as 2, 3 or 4 rechargeable batteries, connected in sequence. In one particular embodiment, battery 24 provides 12 volts of DC power to lighting system 14. In one particular embodiment, battery 24 comprises two-6 volt GS Portalac™ batteries connected in sequence.

Lighting system 14 may incorporate one light 20 or multiple lights 20 interconnected by wiring 22. The lights may be positioned at multiple locations throughout the house. Key areas, such as a fuse box, a staircase or an exit, may be identified and light 20 may be positioned nearby each identified area to provide lighting to crucial areas within a home. One embodiment of the invention incorporates 12-volt lights, however 6-volt and 24-volt lights may be utilized. Lights may be positioned at any height upon a wall of the home. If inhabitants are required to crawl out of a smoke-filled home it may be beneficial to locate some lights closer to the floor.

In the situation that the power supply to AC connection 10 is interrupted, lights 20 of lighting system 14, being interconnected by wiring 22, will be activated. Lighting system 14 accordingly draws power from battery 24. Thus, the length of time that the lighting of lighting system 14 can be sustained is directly related to the amount of charge held by battery 24. Multiple batteries may be utilized to increase the available charge, consequently increasing the amount of time that the lighting may be sustained, or fewer lights 20 may be connected in sequence.

The embodiment shown in FIG. 1 may incorporate a smoke detector as sensor device 18. Accordingly, this embodiment would function so that if either a power outage occurred, or the smoke detector alarm was triggered to sound, the lighting system 14 would be activated and powered by the battery 24. The advantage of this configuration is that when the invention is installed in a home environment it increases the safety of the inhabitants. In the instance of a power outage the lighting system would allow the inhabitants to have sufficient lighting to aid them in finding candles, locating flashlights or alternatively resetting the breaker. In the instance that smoke fills the house, lighting would be provided to help the inhabitants evacuate the building safely. As is apparent, if another type of sensor device is used, the lighting system would also assist inhabitants to evacuate their home safely in the circumstance that another type of dangerous environment is detected within the home at night.

Relay 16 comprises a normally closed contact 32, a switch 33, a normally open contact 35 and a common contact 34. Normally open contact 35 is not used in the present invention. Switch 33 is closed (also referred to herein as being “activated”) in the situation where relay 32 is receiving power, or in the situation where sensor device is not activated by sensor device 18 in response to detection of a dangerous environment by the sensor device. When power is interrupted to switch 33, as by a power outage, or when relay 16 is activated by sensor device 18, switch 33 opens (also referred to herein as being “deactivated”), thereby interrupting power flow through normally closed contact 32. In this situation, power to AC connection 10 is interrupted and lighting system 14 will be turned on and powered by battery 24. Relay 16 can be any of a number of relays known to those skilled in the art. “Relay” as used herein means a device that is activated by variations in an electric circuit and that upon such activation makes or breaks one or more connections in the same or another circuit. Suitable relays for use herein are known to those of skill in the art. In one particular embodiment, relay 16 is a FIREX® Model 0499C relay, that can be used for example with smoke detectors.

Sensor device 18 functions to detect an unsafe environment and will set off an alarm within the device. Sensor device also functions to send a signal to relay 16, via interconnect 40, which signal will cause switch 33 to open, and therefore an interruption in power flow across normally closed connection 32 will occur. This interconnect technology is well known by persons skilled in the art of home alert sensor devices. In one embodiment sensor device 18 may be a smoke detector that will be activated when a sufficient amount of smoke enters the detector chamber to affect the function of the device. One type of smoke detector that may be used in the present invention is a FIREX® Model G-6 smoke detector, however as is apparent many other different types of commonly used smoke detectors would be suitable sensor devices for use herein.

As is also apparent, the sensor devices incorporated in the invention may be of a varied nature including smoke detectors, heat sensors, carbon dioxide monitors, carbon monoxide monitors, fire alarms, gas monitors or other safety devices.

Having thus described the various components of the safety alert and lighting system, various examples of how the various components may be connected or arranged, for example in a home environment, will now be described herein. These examples are not intended to be limiting, and other means of connecting or arranging the various components, as would be known to those of skill in the art, are intended to be included herein.

In the embodiment shown in FIG. 1, wiring connects AC connection 10 to the power source 12 via wall plug 13. In this embodiment two wires connect directly from the power source 12 to the AC connection 10, these wires include: a ground wire 26 and a neutral wire 28. A third hot wire 30 runs between the power source 12 and relay 16. Hot wire 30 attaches to normally closed contact 32 within relay 16. In this embodiment the voltage is 120 volts, however, other voltages may also be applied to the invention depending on the configuration of the elements therein. AC connection 10 is connected to charger 25, which is in turn connected to battery 24.

The normally closed contact 32 is connected to common contact 34 and normally open contact 35. The power flow passes through hot wire 30 and normally closed contact 32 to the common contact 34 from which a hot wire extension 30b extends. Hot wire extension 30b is connected to AC connection 10. Thus power may flow from power source 12, through hot wire 30, through the normally closed contact 32 to common contact 34 via switch 33, and into hot wire extension 30b whereby it will be transmitted the power source connection 10.

The flow of power to the AC connection 10 can be interrupted if the position of switch 33 is altered so that normally closed contact 32 is opened. When normally closed contact 32 is opened, power would flow from power source 12 along hot wire 30 and up to the normally closed contact 32, but as a gap would exist in the normal path of the power, power cannot flow to the common contact 34. Consequently no power may flow through hot wire extension 30b to the AC connection 10 when the normally closed contact 32 is opened. When the normally closed contact 32 is closed, which is its normal state, there is no gap and therefore the flow of the power from the power source 12 to the AC connection 10 is not interrupted.

As shown in the embodiment of FIG. 1, a further connection exists between relay 16 and sensor device 18. Hot 36, neutral 38 and interconnect 40 wires pass between the sensor device 18 and the relay 16.

As has been discussed, the safety alert and lighting system has several distinct functions. The embodiment shown in FIG. 1 may function to activate lighting system 14 if an interruption in power from the power source 12 to hot wire 30 occurs. Such an interruption may be caused by a power outage. The effect of an interruption in power from the power source 12 would be that no power would flow along hot wire 30 and along hot wire extension 30b to AC connection 10. This loss of power to AC connection 10 would cause lighting system 14 to be activated and powered by battery 24.

An alternate function of the safety alert and lighting system is to purposely interrupt the flow of power from the power source 12 to the battery 10. Such an interruption may be caused by the creation of a gap in the power flow path. The gap in the flow of power may be created as a response to the activation of sensor device 18.

Upon activation of sensor device 18, not only may sensor device sound an audible or visual alarm, the sensor device will also send a signal via interconnect 40 to relay 16. Other means of sending a signal from the activated sensor device 18 to relay 16 are intended to be included herein. Relay 16 will recognize the signal sent via interconnect 40, and react thereto. The reaction may be to cause switch 33 to move, and thereby to cause the normally closed contact 32 to be opened. The flow of power will be interrupted when contact 32 is opened, so that no power is able to flow through hot wire extension 30b to AC connection 10. When the AC connection 10 detects a loss of power, lighting system 14 may be activated and powered by battery 24.

When the power outage is over, or when the sensor device is no longer activated, the flow of power is restored to AC connection 10, and the invention will reset itself automatically. Switch 33 will move so that normally closed contact 32 is again closed, lighting system 14 will be deactivated and battery 24 will begin to be recharged.

The embodiment shown in FIG. 2 incorporates a sensor/relay device 42 that comprises both the sensor device 18 and the relay 16 as one device. The wiring would be configured in a slightly altered manner, as opposed to the wiring configuration shown in FIG. 1, to facilitate the function of this embodiment of the invention. FIG. 2 further demonstrates direct wiring to power source 12, rather than connection via wall plug 13. Direct wiring to power source 12 incorporates wiring connections that are different from those in the embodiment shown in FIG. 1.

In the embodiment shown in FIG. 2, hot wire 30 may extend from power source 12 to normally closed contact 32 and a neutral wire 28 may extend from power source 12 to AC connection 10. Through switch 33, between normally closed contact 32 and common contact 34, the power may flow into hot wire extension 30b extending from the common contact. The hot wire extension 30b may connect directly to the AC connection 10.

A second hot wire 36 may extend from power source 12 to sensor/relay device 42. Likewise a second neutral wire 38 may extend from the power source 12 to sensor/relay device 42. An interconnect wire 40 may extend from sensor/relay device 42, and may be connected to multiple sensor devices so as to cause the activation of all connected sensor devices if one sensor device is activated due to the detection of an unsafe environment.

The embodiment shown in FIG. 2 functions in a manner similar to the embodiment shown in FIG. 1. Upon activation of sensor/relay device 42, switch 33 will move and normally closed contact 32 will be opened. The resulting gap will interrupt the flow of power from power source 12 to AC connection 10. Upon AC connection 10 sensing that no external power is flowing to it from power source 12, lighting system 14 will be activated and powered by battery 24. Alternatively, lighting system 14 may be activated if power stops flowing from power source 12, which may result from a power outage.

In the embodiment shown in FIG. 3, hot wire 30 may extend from wall plug 13 to AC connection 10. Relay 16 is connected to sensor device 18 (not shown) via interconnect 40, hot wire 36 and neutral wire 38. A hot wire extension 30b extends from normally closed contact 32 to wall plug 13. Neutral wire 28 may extend from wall plug 13 to AC connection 10, and a second neutral wire 38 extends from wall plug 13 to relay 16. Ground wire 26 extends from wall plug 13 to AC connection 10. Through switch 33, between normally closed contact 32 and common contact 34, the power may flow from hot wire 36, into hot wire extension 30b extending from normally closed connection 32, to wall plug 13 and through to AC connection 10.

The embodiment shown in FIG. 3 functions in a manner similar to the embodiments shown in FIG. 1 and 2. Upon activation of sensor device 18, a signal is sent to relay 16 via interconnect 40, which causes switch 33 to move and normally closed contact 32 to be opened. The resulting gap will interrupt the flow of power from relay 16 to wall plug 13, which will in turn cause power flow to AC connection 10 to stop. Upon AC connection 10 sensing that no power is flowing to it, lighting system 14 will be activated and powered by battery 24. Alternatively, lighting system 14 may be activated if power stops flowing from wall plug 13, which may result from a power outage.

FIG. 4 shows an embodiment of the invention incorporating multiple sensor devices 44 and 46 and a device 48 that is activated or inactivated when one of the sensor devices in this embodiment is activated in response to an unsafe environment. All of 44, 46 and 48 are in connection with sensor/relay device 42. In this embodiment, sensor/relay device 42 is wired in the same manner as shown in FIG. 2 with hot wire 30 and neutral wire 28 connecting sensor/relay device 42 to power source 12 and to AC connection 10, relay 16 and sensor 18. An interconnect wire 40 extends from sensor 18 to a plurality of sensor devices 44 and 46 to ensure that each sensor device will be activated upon the occasion that one of the sensor devices has been activated due to detection of an unsafe environment. Thus, as shown in FIG. 4, in the circumstance that sensor 44, which may be a heat detector, senses an unsafe environment and is activated, sensor/relay device 42, which may be a smoke detector/relay, and sensor device 46 which may be a carbon monoxide monitor, will also be activated, due to signals being passed along interconnect wire 40. The interconnect wiring is standard in the art of home sensor devices. As discussed above, when normally closed connection 32 in relay 16 is opened, power to AC connection will be interrupted, and lighting system 14 will be activated and will be powered by battery 24.

Several sensor devices, for example, 3, 7 or 12 sensor devices, of the same type or a variety of different types may be incorporated into an embodiment of the invention and located throughout the house. Thus, a gas monitor could be located near a gas fireplace while a smoke detector is located in the kitchen and a heat sensor is placed in a hallway. Alternatively, one or more sensor devices of the same type may be included in an embodiment of the invention. Each sensor device is wired to connect to hot wire 36, neutral wire 38 and interconnect wire 40 to another sensor device, as is known by those of skill in the art.

A device 48, as shown in FIG. 4, may be incorporated into an embodiment of the invention through a relay connected to a sensor device. As mentioned, device 48 may be activated or inactivated when one of the sensor devices is activated in response to an unsafe environment. In FIG. 4 is demonstrated an embodiment wherein device 48 is inactivated. FIG. 4 shows a second sensor/relay device 50 connected to device 48, which in this embodiment is a furnace. The power source 12, a second relay 52 and furnace 48 are wired in a manner similar to the wiring of power source 12, relay 16 and battery 24. In the embodiment shown in FIG. 4, a hot wire 54 extends from power source 12 to a common contact 56 that is connected to a normally closed contact 58. A coil 60 connects the hot wire 36 and neutral wire 38 of the sensor device 46 to the relay 52 within it. The wiring connecting the relay and the battery or any other device may be either to the normally closed contact or to the common contact as shown in FIG. 4. In FIG. 4 the wiring shown between battery 24 and relay 16 is different than that shown between furnace 48 and second relay 52. Each wiring configuration will function to create a gap in the flow of power in response to the activation of a sensor device.

In the embodiment shown in FIG. 4 specifically, if sensor device 46 is a carbon monoxide monitor that becomes activated because it detects unsafe levels of carbon monoxide, it sounds its alarm, and the second relay 52 responds, as has already been discussed, and causes the normally closed contact 58 to be opened. The flow of power from the power source to the furnace via hot wire extension 54a is thereby interrupted so that furnace 48 no longer receives power and is rendered inactive. Additionally, relay 16 responds and lighting system 14 will activated and powered by battery 24. Alternatively, in this embodiment, if sensor device 18 is a smoke or heat detector that becomes activated, it sounds its alarm, and both relay 16 and the second relay 52 respond, as has already been discussed. In the final result, lighting system 14 will be activated and will be powered by battery 24, and furnace 48 will be rendered inactive.

This embodiment may incorporate any number of devices connected via a relay to a sensor device. A sensor/relay device may be utilized, as shown in FIG. 4, or a separate sensor device and relay may be utilized, as shown in FIG. 1.

The purpose of deactivating external devices through this configuration of the invention is to avert further risks to inhabitants and property that may be caused by the interaction between an unsafe environment detected somewhere within the home and certain devices within the home. Devices that pose a threat if they are left active, such as water pipes, gas lines, gas fireplaces, or other devices, may be incorporated into the embodiment of the invention shown in FIG. 4 in the same manner as the furnace is shown to be connected, so that they may be deactivated if an unsafe environment is detected. The deactivation of such devices may decrease risk to the inhabitants while they exit their home, as well as risk of further property damage.

While the invention has been described in conjunction with the disclosed embodiments, it will be understood that the invention is not intended to be limited to these embodiments. On the contrary, the invention is intended to cover alternatives, modifications and equivalents, which may be included within the spirit and scope of the invention as defined by the appended claims.

What is claimed is:

1. A safety alert and lighting system comprising:
(a) a power source;
(b) an AC connection connected to the power source,
(c) a relay disposed between the power source and the AC connection, said relay being connected to the power source and to the AC connection, and said relay comprising a switch which when deactivated will interrupt power flow to the AC connection;
(d) a battery connected to a charger;
(e) a charger connected to the AC connection;
(f) a lighting system connected to the battery and powered by the battery when the switch is deactivated; and
(g) a sensor device capable of being activated, connected the relay
wherein the switch is deactivated when power flowing from the power source to the relay is interrupted, or when the sensor device is activated.

2. A safety alert and lighting system according to claim 1 wherein the sensor device is a safety alert device.

3. A safety alert and lighting system according to claim 2 wherein the safety alert device is a smoke detector.

4. A safety alert and lighting system according to claim 1 wherein the lighting system comprises at least one light positioned so as to provide optimum lighting in a smoke-filled environment.

5. A safety alert and lighting system according to claim 1 wherein the switch is moveable.

6. A safety alert and lighting system according to claim 5 wherein the switch moves between position in which it contacts a normally closed contact and a position in which it does not contact the normally closed contact.

7. A safety alert and lighting system according to claim 6 wherein the normally closed contact is connected to the flow of power from the power source.

8. A safety alert and lighting system according to claim 1 wherein the battery is rechargeable.

9. A safety alert and lighting system according to claim 8 wherein the battery is recharged by power flowing from the AC connection.

10. A safety alert and lighting system comprising:
(a) a power source;
(b) an AC connection connected to the power source and to a charger
(c) a battery connected to the charger,
(d) a lighting system capable of being powered by the battery;
(e) at least one sensor device capable of being activated; and
(f) a relay connected to: (i) the power source, (ii) the sensor and (iii) the AC connection, said relay comprising at least one switch that is capable of interrupting the power flow to the AC connection when either: (i) power flowing from the power source to the relay is interrupted or (ii) the at least one sensor device is activated,
and wherein, when said relay interrupts the power flow to the AC connection, the lighting system is powered by the battery.

11. A safety alert and lighting system according to claim 10 wherein the at least one sensor device is a safety alert device.

12. A safety alert and lighting system according to claim 11 wherein the at least one safety alert device is a smoke detector.

13. A safety alert and lighting system according to claim 10 comprising two or more sensor devices.

14. A safety alert and lighting system according to claim 13 wherein the two or more sensor devices are activated in response to two or more different unsafe environments.

15. A safety alert and lighting system according to claim 10 wherein the lighting system comprises at least one light positioned to provide optimum lighting in a smoke-filled environment.

16. A safety alert and lighting system according to claim 10 wherein said at least one switch is a moveable switch.

17. A safety alert and lighting system according to claim 16 wherein the switch moves between position in which it contacts a normally closed contact and a position in which it does not contact the normally closed contact upon being triggered by the sensor device or upon loss of power flow to the relay.

18. A safety alert and lighting system according to claim 17 wherein the normally closed contact is connected to the flow of power from the power source.

19. A safety alert and lighting system according to claim 10 wherein the battery is rechargeable.

20. A safety alert and lighting system according to claim 19 wherein the battery is recharged by power flowing from the AC connection.

21. A safety alert and lighting system comprising:
(a) a power source;
(b) a first relay disposed between the power source and a AC connection, said relay being connected to the power source and to the AC connection, and said relay comprising a first switch which when deactivated will interrupt power flow to the AC connection;
(c) at least one second relay connected to the first relay, said second relay being connected to the power source and to at least one device, and said second relay comprising a second switch which when deactivated will either interrupt the power flow, or cause power to flow, to the device;
(d) at least one sensor device that is capable of being activated, connected to the first relay;
(e) a battery connected to a charger;
(f) a charger connected to the AC connection and to a lighting system that is powered by the battery when the power flow to the AC connection is interrupted;
wherein, when power flowing from the power source to the first relay is interrupted, or when power flowing to the second relay is interrupted, or when the at least one sensor device is activated, the first switch is deactivated and the lighting system is powered by the battery, and the second switch is deactivated.

22. A safety and lighting system according to claim 21 wherein when the second switch is deactivated, the power flow to the at least one device will be interrupted.

23. A safety alert and lighting system according to claim 22 comprising two or more sensor devices.

24. A safety alert and lighting system according to claim 23 wherein one sensor device is a smoke detector and one sensor device is a gas monitor.

25. A safety alert and lighting system according to claim 24 wherein the at least one device is a furnace.

26. A safety alert and lighting system according to claim 21 wherein the battery is rechargeable.

27. A safety alert and lighting system according to claim 21 wherein the lighting system comprises at least one light positioned so as to provide optimum lighting in a smoke-filled environment.

28. A safety alert and lighting system according to claim 21 wherein either or both of the first switch and the second switch is a moveable switch.

29. A safety alert and lighting system according to claim 28 wherein the first switch moves between a position in which it contacts a normally closed contact and a position in which it does not contact the normally closed contact upon being triggered by the at least one sensor device or upon loss of power flow to the first relay.

30. A safety alert and lighting system according to claim 28 wherein the second switch moves between a position in which it contacts a normally closed contact and a position in which it does not contact the normally closed contact upon being triggered by the at least one sensor device.

31. A safety alert and lighting system according to claim 29 wherein the normally closed contact is connected to power flowing from the power source.

32. A safety alert and lighting system according to claim 21 wherein the battery is rechargeable.

33. A safety alert and lighting system according to claim 32 wherein the battery is recharged by power flowing from the AC connection.
